(19) United States
(12) Patent Application Publication
(10) Pub. No.: US 2009/0271434 A1
(43) Pub. Date: Oct. 29, 2009

(54) Method and System for Storing Trace Data

(76) Inventor: H. Allan GEORGE, Mulgrave (CA)

Correspondence Address: FAY KAPLUN & MARCIN, LLP, 150 BROADWAY, SUITE 702, NEW YORK, NY, 10038, US

(21) Appl. No.: 12/111,402

(22) Filed: Apr. 29, 2008

(51) Int. Cl. G06F 17/30

(52) U.S. Cl. 707/103 R; 707/E17.009

(57) ABSTRACT

A method includes capturing a plurality of trace capture records and storing the plurality of trace capture records in a trace acquisition protocol record. The trace acquisition protocol record further storing a single timestamp record and a plurality of flag records. A number of flag records corresponds to a number of trace capture records stored in the trace acquisition protocol record.

### BACKGROUND

Software developers may typically wish to log events that occur during the execution process. Recorded information may then be useful during debugging or other processes carried out on development or other software. However, software developers may wish to minimize the amount of storage space required to record such information while retaining the same utility of the recorded information.

### SUMMARY OF THE INVENTION

The present invention relates to a method including capturing a plurality of trace capture records and storing the plurality of trace capture records in a trace acquisition protocol record. The trace acquisition protocol record further storing a single timestamp record and a plurality of flag records. A number of flag records corresponds to a number of trace capture records stored in the trace acquisition protocol record.

The present invention also relates to a system including a processor and a memory. The processor executes instructions to capture trace capture records from a software program executing on a target device. The memory stores the plurality of trace capture records in a trace acquisition protocol record. The memory further stores a single timestamp record and a plurality of flag records in the trace acquisition protocol record. A number of flag records corresponds to a number of trace capture records.

The present invention also relates to a system including a memory storing a set of instructions and a processor configured to execute the instructions. The instructions are operable to capture a plurality of trace capture records and store the plurality of trace capture records in a trace acquisition protocol record. The trace acquisition protocol record further stores a single timestamp record and a plurality of flag records. A number of flag records corresponds to a number of trace capture records stored in the trace acquisition protocol record.

### BRIEF DESCRIPTION OF THE DRAWINGS

FIG. 1 shows exemplary memory devices for implementing trace storage according to the present invention.

FIG. 2 shows an exemplary memory burst for the devices of FIG. 1 to comprise a trace record according to the present invention.

FIG. 3 shows the contents of an exemplary trace acquisition protocol record according to the present invention.

FIG. 4 shows the contents of an exemplary capture record according to the present invention.

FIG. 5 shows the contents of an exemplary flag record according to the present invention.

FIG. 6 shows the contents of an exemplary time stamp record according to the present invention.

FIG. 7 shows the contents of an exemplary protocol-specific record according to the present invention.

FIG. 8 shows an alternate view of the exemplary trace acquisition protocol record of FIG. 3.

### DETAILED DESCRIPTION

The exemplary embodiments of the present invention may be further understood with reference to the following description and the appended drawings, wherein like elements are referred to with the same reference numerals. The exemplary embodiments of the present invention describe methods and systems for improving the utility of system calls created by debuggers and other tools for monitoring the operation of other applications.

During program development and debugging, a developer may wish to create and monitor records of various processes, variables, instructions, etc. that the program in development is handling through various points during execution. A record of such data may be known as a trace. A typical trace may include, for example, a record of all tasks that a program is performing at a particular point during its execution.

Existing methods for capturing and storing a trace from a target program may typically record a time stamp on every cycle. Further, a trace may be stored in memory with any associated acquisition flags. As a result of these factors, more memory may be required for the time stamp and the acquisition flags than for actual substantive target data. The exemplary embodiments of the present invention provide for more efficient memory utilization.

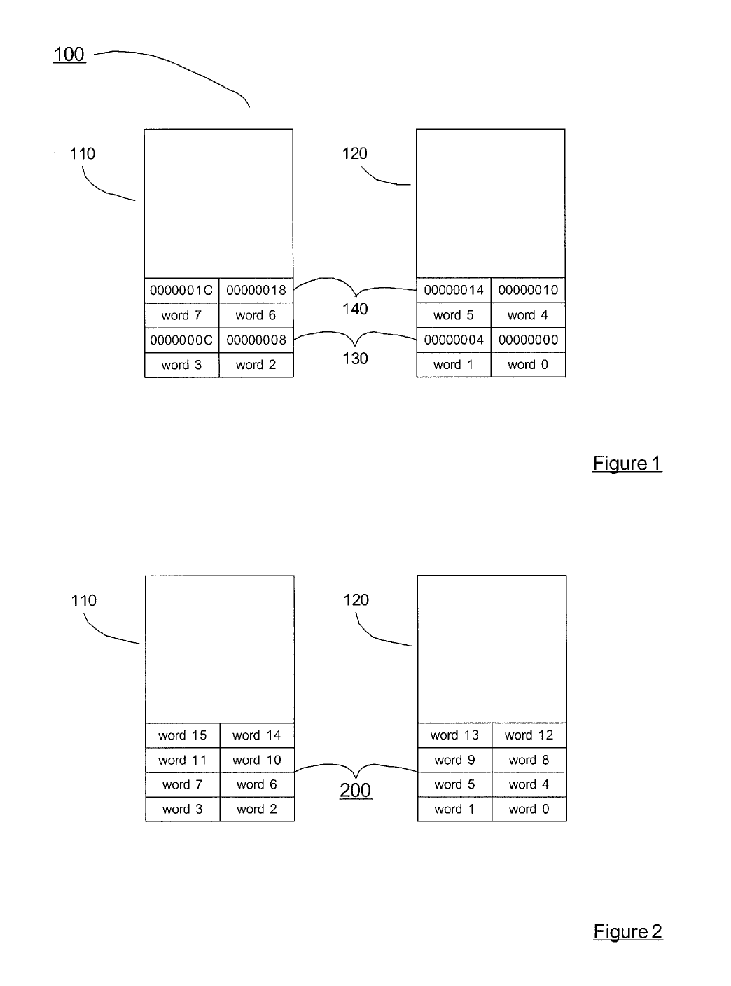

FIG. 1 illustrates a memory arrangement 100 according to an exemplary embodiment of the present invention. The memory arrangement 100 includes two DDR2 devices 110 and 120. Those skilled in the art will understand that a DDR2 device refers to a double data rate two synchronous dynamic random access memory (“SDRAM”) device. While the exemplary embodiment is described with reference to such devices, those skilled in the art will understand that the present invention is not limited to application in only these type of devices, but may be applied to any device that is used to store trace data.

Continuing with the example of FIG. 1, the two DDR2 devices 110 and 120 are each 64 bits wide. Thus, each memory location (e.g., memory locations 130 and 140) may contain 128 bits (64 bits in DDR2 110 and 64 bits in DDR2 120). Each of the two DDR locations 130 and 140 include four 32-bit words. In this example, PCI addresses 00000000, 00000004, 00000008 and 0000000C may access 32-bit words 0, 1, 2 and 3, respectively, in DDR memory location 130; PCI addresses 00000010, 00000014, 00000018 and 0000001C may access 32-bit words 4, 5, 6 and 7, respectively, in DDR memory location 140.

FIG. 2 illustrates an exemplary memory access 200 utilizing the DDR2 devices 110 and 120. The memory access 200 may comprise a burst of four DDR memory locations, or 512 bits in total. Each 512-bit burst may thus be equivalent to sixteen 32-bit words; this group of words may be collectively defined as a Trace Acquisition Protocol (“TAP”) record. Those of skill in the art will understand that in this exemplary embodiment, the burst size is 512-bits and thus, the TAP record is defined as being 512 bits. However, if another type of memory has a different burst size, the size of the TAP record may be adjusted accordingly. As can be seen from this example, an efficient size for the TAP record may be a multiple of the memory burst size.

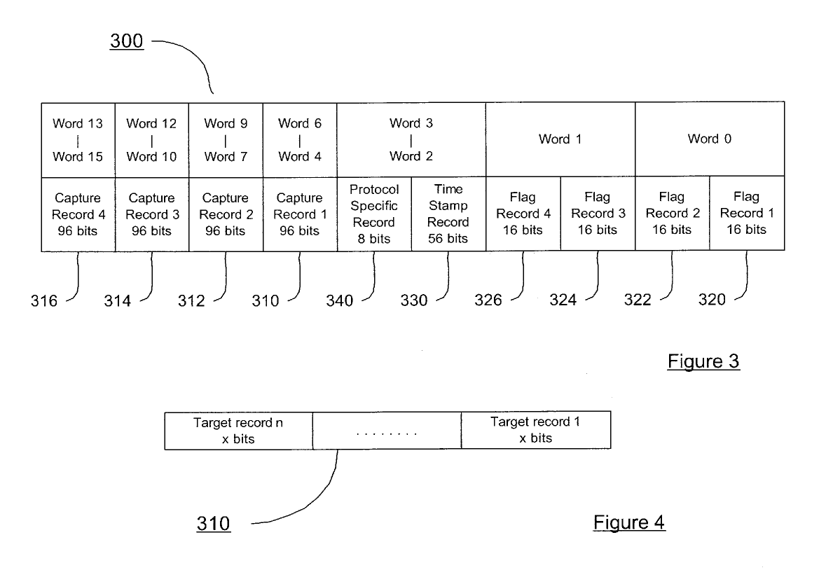

FIG. 3 illustrates the contents of an exemplary Trace Acquisition Protocol (“TAP”) record 300 corresponding to the words 0-15 accessed in the memory burst illustrated in FIG. 2. The record 300 may include four capture records 310 (words 4-6), 312 (words 7-9), 314 (words 10-12) and 316 (words 13-15). Each of the capture records may typically comprise 96 bits of data, i.e. three 32-bit words as discussed above. A single capture record (e.g., capture record 310) may contain from 1 to n target records, each of which comprises x bits. The value of x may depend on the specific target being traced; various exemplary embodiments of the present invention may include a value of x that is 4 bits, 6 bits, 8 bits, 12 bits, 16 bits or 32 bits.

FIG. 4 illustrates an exemplary composition of the capture record 310. As discussed above, the capture record 310 may contain n target records of x bits in size. For example, if x is 12 bits, n may be 8 target records, for a total of 96 bits. Those of skill in the art will understand that the use of capture record 310 is only exemplary, and that the capture records 312, 314 and 316 may also be represented by FIG. 4.

Returning to FIG. 3, the TAP record 300 may also include flag records 320, 322 (word 0) and 324, 326 (word 1). In this exemplary embodiment, the flag records may be 16 bits in size. Each bit within the flag record may be used to represent whether a corresponding condition is true. FIG. 5 illustrates an exemplary flag record (e.g., the flag record 320). The flag record 320 may include a GAP bit 505, which may indicate whether any records have been missed between the currently-traced record and the previously-traced record. The flag record 320 may also include a record flushed (“RF”) bit 510, indicates that a partial trace is held in the trace pipeline and needs to be flushed; such a partial trace may be recorded when the trace system is stopped for any reason. The flag record 320 may also include a two-bit before trace (“BT”) location 515, which may define the entry, exit and size of the before trace circular buffer. The flag record 320 may also include event flags 520, 525, 530, 535, 540, 545, 550 and 555, which may represent the results of eight independent comparisons that may be dynamically performed on the trace data as it is being stored into the capture record 310. The flag record 320 may further include a blank record bit 560 that may indicate that the associated capture record 310 contains no data. The flag record 320 may also include a not unused bit 565, which may have a future use assigned to it as needed. Finally, the flag record 320 may include a two-bit level location 570, which may specify the level of the trace record. That is, the TAP may nest to several levels and each TAP record may be identified to its nesting level.

Referring back to FIG. 3, the TAP record 300 may also include a 56-bit time stamp record 330 (word 2-3), the contents of which are illustrated in FIG. 6. The time stamp record 330 includes a 54-bit time stamp value 610 and a two-bit association value 620. In this exemplary embodiment, the time stamp value 610 may be based on a 200 MHz free running clock, which thus may provide resolution to 5 nanoseconds. For this set of parameters (i.e., a 200 MHz clock and 54-bit time stamp storage), the time stamp value 610 may take 2.85 years of continuous operation before it must roll over. Those of skill in the art will understand that these values are only exemplary and that other embodiments may use different parameters. The association value 620 may indicate which of the capture records (e.g., capture records 310, 312, 314 or 316) the time stamp value 610 is associated with, as shown in FIG. 6.

Again referring back to FIG. 3, the TAP record 300 may also include an 8-bit protocol-specific record 340 (word 2-3), which may be specific to the supported target protocol. As noted in this exemplary embodiment, since the time stamp record 330 is 56 bits, it may be split between two words (e.g., words 2-3), while the remaining unused 8 bits of one of the words may be used for the protocol-specific record 340. In one exemplary embodiment, the target protocol may be the ARM ETMv3 protocol, which is an 8-bit protocol based on packets comprised of a number of 8-bit quantities. The packets may be broken up into an 8-bit header followed by an optional payload. The ETMv3 protocol supports trace port sizes of various widths; therefore, it may be possible for the captured trace to be misaligned with the byte boundary when sub-byte port widths are used. The protocol has a unique header alignment sequence of five contiguous A-sync headers followed by a null P-header that identifies the next 8-bit value as a header for synchronization. This unique header alignment sequence is detected dynamically by the acquisition system during trace capture to guarantee byte alignment. The acquisition system uses the protocol-specific record 340 as an alignment record to mark this event during capture, so that decompression software may use it to synchronize with the packet headers without having to detect the full alignment sequence.

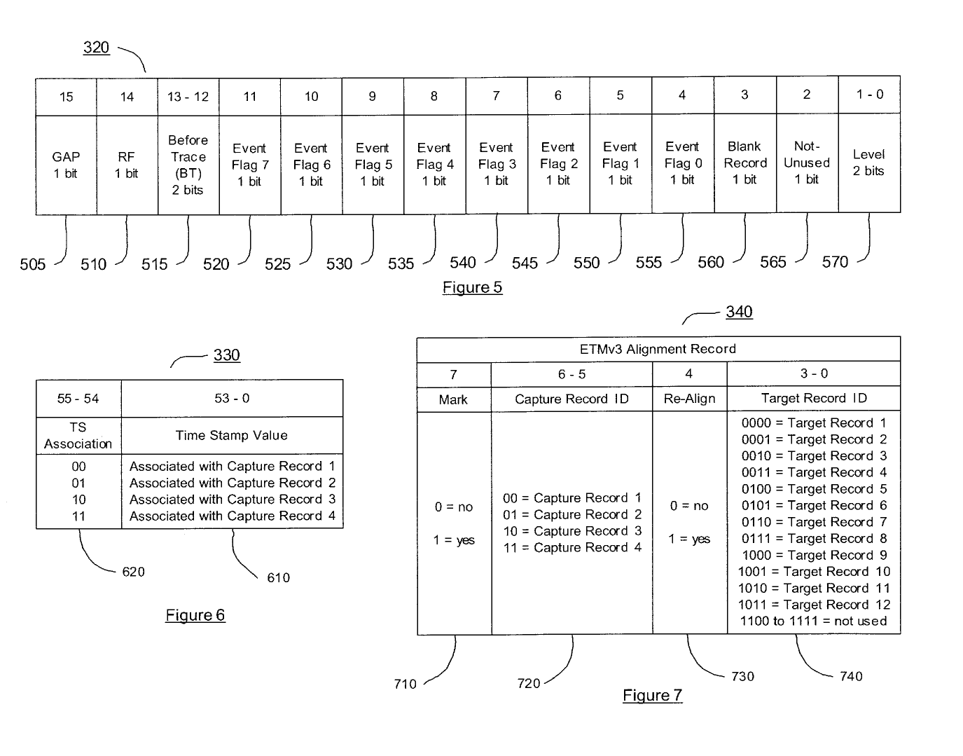

FIG. 7 illustrates an exemplary protocol-specific record 340 for embodiments that use the ETMv3 protocol. The record 340 may include a one-bit mark field 710 that may indicate whether there is an alignment sequence mark in the TAP record 300. The record 340 may also include a two-bit capture record identification field 720, which may identify the capture record (e.g., capture records 310, 312, 314 or 316) that may contain the marked target record. The record 340 may also include a one-bit re-align field 730, which may indicate that the trace prior to the current alignment sequence was out of sync and had to be re-aligned. (Those of skill in the art will understand that this should never happen under normal trace capture conditions.) Finally, the record 340 may contain a four-bit target record identification field 740, which may indicate which target record (as illustrated in FIG. 4) is marked as the packet header immediately following an alignment synchronization sequence.

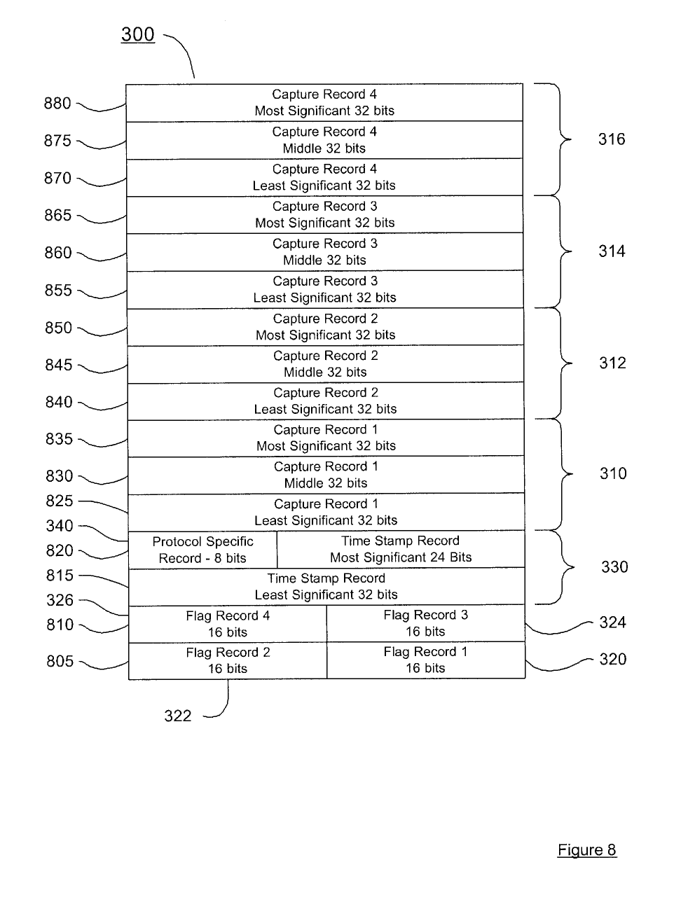

FIG. 8 illustrates a different view of the TAP record 300. The view shown in FIG. 8 illustrates the record 300 as it may be viewed by software, as sixteen separate 32-bit words (totaling 512 bits, as discussed above). Word 0 (805) may include two flag records 320 and 322, as described above. Word 1 (810) may include the remaining two flag records 324 and 326. Word 2 (815) may include the least significant 32 bits of the time stamp record 330. Word 3 (820) may include the remainder (e.g., the most significant 24 bits) of the time stamp record 330 and the protocol-specific record 340. Word 4 (825) may include the least significant 32 bits of the first capture record 310. Word 5 (830) may include the middle 32 bits of the capture record 310, while word 6 (835) may include the remaining 32 bits (e.g., the most significant 32 bits) of the capture record 310. Similarly, words 7, 8 and 9 (840, 845, 850) may contain the capture record 312; words 10, 11 and 12 (855, 860, 865) may contain the capture record 314; and words 13, 14 and 15 (870, 875, 880) may contain the capture record 316.

The exemplary embodiments of the present invention provide for improved efficiency of memory utilization as compared to previously existing trace storage methods. Prior methods may include a time stamp on every cycle, which is stored in memory along with any associated acquisition flags. Such an approach may result in the use of more memory to store the timestamp and flags than to store the actual target data. In contrast, the exemplary embodiments of a Trace Acquisition Protocol record according to the present invention store a single record comprising four capture records, each of which may contain multiple target records. Each record further includes four associated flag records, one timestamp record, and one protocol-specific record. Thus, the overhead required for timestamp and flag records is minimized. Further, because the size of a Trace Acquisition Protocol record is defined as an even multiple of the memory burst size, the process of storing and retrieving records may be streamlined and efficient.

Those skilled in the art will understand that the sizes of the various fields described for the exemplary TAP record 300 are described with reference to the ARM-ETMv3 protocol and are only exemplary. The sizes of the fields may be varied depending on the particular processor protocol on which the software is being executed.

Those skilled in the art will understand that the above-described exemplary embodiments may be implemented in any number of manners, including as a separate software module, as a combination of hardware and software, etc. For example, the Trace Acquisition Protocol record 300 may be assembled by a program containing lines of code that, when compiled, may be executed by a processor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A method, comprising:
capturing a plurality of trace capture records; and
storing the plurality of trace capture records in a trace acquisition protocol record, the trace acquisition protocol record further storing a single timestamp record and a plurality of flag records, wherein a number of flag records corresponds to a number of trace capture records stored in the trace acquisition protocol record.

2. The method of claim 1, wherein each of the plurality of trace records include one or more target records.

3. The method of claim 1, wherein each of the flag records corresponds to one of the trace capture records.

4. The method of claim 1, wherein the timestamp record includes a timestamp value and a timestamp association field.

5. The method of claim 1, wherein the timestamp association field identifies one of the trace capture records with which the timestamp value is associated.

6. The method of claim 1, wherein the trace acquisition protocol record further includes a protocol specific record storing data corresponding to a supported target protocol.

7. The method of claim 1, further comprising:
capturing a further plurality of trace capture records; and
storing the further plurality of trace capture records in a second trace acquisition protocol record, the second trace acquisition protocol record further storing a further single timestamp record and a plurality of further flag records, wherein a number of further flag records corresponds to a number of further trace capture records stored in the second trace acquisition protocol record.

8. A system, comprising:
a processor executing instructions to capture trace capture records from a software program executing on a target device; and
a memory storing the plurality of trace capture records in a trace acquisition protocol record, the memory further storing a single timestamp record and a plurality of flag records in the trace acquisition protocol record, wherein a number of flag records corresponds to a number of trace capture records.

9. The system of claim 8, wherein each of the plurality of trace records include one or more target records.

10. The system of claim 8, wherein each of the flag records corresponds to one of the trace capture records.

11. The system of claim 8, wherein the timestamp record includes a timestamp value and a timestamp association field.

12. The system of claim 8, wherein the timestamp association field identifies one of the trace capture records with which the timestamp value is associated.

13. The system of claim 8, wherein the trace acquisition protocol record further includes a protocol specific record storing data corresponding to a supported target protocol.

14. A system comprising a memory storing a set of instructions and a processor configured to execute the instructions, wherein the instructions are operable to:
capture a plurality of trace capture records; and
store the plurality of trace capture records in a trace acquisition protocol record, the trace acquisition protocol record further storing a single timestamp record and a plurality of flag records, wherein a number of flag records corresponds to a number of trace capture records stored in the trace acquisition protocol record.
